(19) United States
(12) Patent Application Publication
(10) Pub. No.: US 2009/0306877 A1
(43) Pub. Date: Dec. 10, 2009

(54) COMBUSTION CONTROL SYSTEM FOR INTERNAL COMBUSTION ENGINE WITH RICH AND LEAN OPERATING CONDITIONS

(75) Inventors: Shizuo Sasaki, San Antonio, TX (US); Gary D. Neely, Boerne, TX (US); Jayant V. Sarlashkar, San Antonio, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Southwest Research Insititute, San Antonio, TX (US)

(21) Appl. No.: 12/134,598

(22) Filed: Jun. 6, 2008

(51) Int. Cl. F02D 41/30; F02D 41/34

(52) U.S. Cl. 701/104; 701/105

(57) ABSTRACT

A method of controlling combustion of an internal combustion engine that use fuel injection and that uses lean and rich modes of operation. Combustion control values, such as for fuel injection timing and quantity are determined by a torque representative value. This value is obtained from estimated in-cylinder conditions and from engine speed.

### TECHNICAL FIELD OF THE INVENTION

This invention relates to engine control systems, and more particularly to an engine control system that controls fuel injection (for direct injection engines) or spark timing (for spark ignited engines).

### BACKGROUND OF THE INVENTION

Today's conventional control systems for diesel engines (or other internal combustion engines that use direct fuel injection) are “fuel-based”. In response to activity of the accelerator pedal, an engine control unit determines the quantity of fuel to inject. Downward action of the accelerator pedal causes the engine control unit to inject more fuel.

Typical fuel-based engine control calibrations utilize high excess air ratios which do not result in combustion that is sensitive to variations in in-cylinder conditions. In particular, the combustion is not sensitive to airflow mass, air fuel ratio, or exhaust gas recirculation (EGR) rate. For some modern diesel engines, fuel injection is adjusted based on airflow mass measurement to control soot in small regions of the operating range, but this control method is still primarily fuel-based.

U.S. Patent No. 7,163,007 describes an “oxygen-based” combustion control system. For both lean and rich operating conditions, an estimated in-cylinder oxygen amount (oxygen mass) is used to determine fueling parameters. For transient operating conditions (rich-to-lean or lean-to-rich), in addition to current oxygen mass, an oxygen mass ratio between lean and rich is used to determine the fueling parameters.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example of an engine having fuel injection and capable of operating in lean and rich modes, and having a control unit that operates in accordance with the methods described herein.

FIG. 2 illustrates the relationship between engine torque and in-cylinder oxygen mass for optimal combustion in Modes 1 and 2.

FIG. 3 illustrates the relationships between engine torque and in-cylinder oxygen mass from EGR and from fresh air.

FIG. 4 illustrates a fresh air flow function used to determine a representative value for in-cylinder oxygen mass.

FIG. 5 illustrates Mode 2 tables that map fresh air flow weighting values, temperature representative values, and engine speed to fresh air ratio values.

FIG. 6 illustrates Mode 2 tables that map fresh air function values, temperature representative values, and engine speed to fresh air flow weighting values.

FIG. 7 illustrates Mode 2 tables that map fresh air flow weighting values, temperature representative values, and engine speed to steady-state oxygen EGR values.

FIG. 8 illustrates Mode 2 tables that map fresh air representative values, temperature representative values, and engine speed values to torque representative values.

FIG. 9 illustrates Mode 2 tables that map torque representative values, temperature representative values, and engine speed values to fueling parameter values.

FIG. 10 illustrates Mode 2 tables that map torque representative values, temperature representative values, and engine speed values to fueling timing parameter values.

FIG. 11 illustrates the optimal relationship between oxygen concentration at steady state and injection timing.

FIG. 12 illustrates Mode 2 tables that map torque representative values, temperature representative values, and engine speed values to the oxygen concentration at steady state.

FIG. 13 illustrates Mode 2 tables that map torque representative values, temperature representative values, and engine speed values to values used in the representative oxygen mass calculation.

FIG. 14 illustrates the Mode 2 (lean combustion) control process.

FIG. 15 illustrates how the process of FIG. 14 eliminates the need for a different Mode 1 control process.

FIG. 16 illustrates how the representative oxygen mass value is gradually reduced for switching from Mode 0 to Mode 2.

FIG. 17 illustrates Mode 3 tables that map air handling representative values and engine speed values to air handling position values.

FIG. 18 illustrates Mode 3 tables that map in-cylinder oxygen mass values, temperature representative values, and engine speed values to torque representative values.

FIG. 19 illustrates Mode 3 tables that map torque representative values, temperature representative values, and engine speed values to various fueling parameter values.

FIG. 20 illustrates Mode 3 tables that map torque representative values, temperature representative values, and engine speed values to combustion timing values.

FIG. 21 illustrates Mode 3 tables that map torque representative values, temperature representative values, and engine speed values to the oxygen concentration at steady state for use in correcting the combustion timing values of FIG. 20.

FIG. 22 compares, for Modes 2 and 3, the curves of torque representative values for varying values of oxygen mass and torque.

FIG. 23 illustrates mode timing for values of pedal position, air handling representative, oxygen mass, torque representative, fuel quantity, A/F ratio, and torque.

FIG. 24 illustrates Mode 23 tables that map engine speed values and pedal position values to air handling representative values, which are then mapped to torque representative values.

FIG. 25 illustrates Mode 23 tables that map oxygen difference values, torque representative values, temperature representative values, and engine speed values to air handling representative overshooting values.

FIG. 26 illustrates Mode 23 tables that map torque representative values and engine speed values to A/F ratio values.

FIG. 27 illustrates the control process for Mode 23.

FIG. 28 illustrates the control process for Mode 3.

FIG. 29 illustrates the control process for Mode 32.

FIG. 30 illustrates Mode 32 tables that map engine speed values and pedal position values to air handling representative values, which are then mapped to torque representative values.

FIG. 31 illustrates Mode 32 tables that map oxygen difference values, torque representative values, and engine speed values to air handling representative overshooting values.

FIG. 32 illustrates Mode 32 tables that map torque representative values and engine speed values to A/F ratio values.

### DETAILED DESCRIPTION OF THE INVENTION

### 1. Overview

The following description is directed to engine control methods suitable for use with an internal combustion engine that operates with both lean and rich combustion modes. Examples of such engines may include both diesel engines and stratified charge engines (both gasoline and diesel).

These engines must be capable of smooth and efficient switching between the rich and lean modes. For example, these types of engines may be used with emissions after treatment devices (such as lean Nox traps) that require switching from lean to rich mode during periodic regeneration and then back to lean mode.

The combustion control parameters for these engines may include fueling parameters (such as for direct diesel fuel injection into the cylinder) and/or ignition timing parameters (such as for spark ignition of an air-gasoline mixture). Fueling parameters may include injection quantity, pressure, number of injections, and injection timing. The concepts described herein are applicable regardless of whether the engine is direct injection or spark ignited; the term “combustion control parameters” is used herein to include either fueling or spark timing parameters for any type of fuel injection engine.

As explained below, one feature of the invention is that combustion control parameters are determined by various factors, one of which is a “torque representative factor” referred to herein as “k”. Despite the operating mode (lean, rich, or transient), a desired relation between k and torque is maintained.

For purposes of this description, the following engine control modes are recognized:

| | |
|---|---|
| Mode 0 | idle |
| Mode 1 | negative engine torque |
| Mode 2 | lean |
| Mode 3 | rich |
| Mode 23 | transient lean to rich |
| Mode 32 | transient rich to lean |

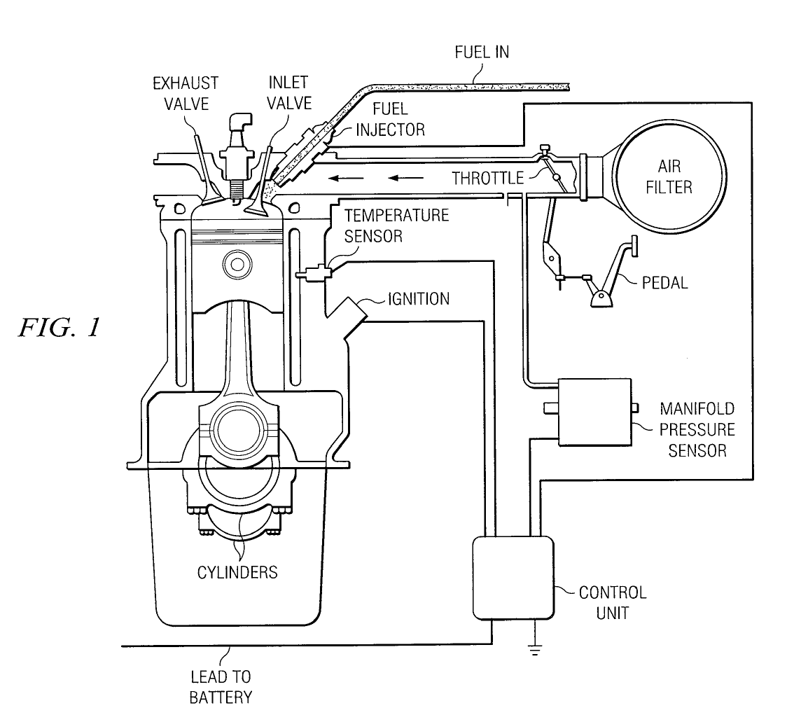

FIG. 1 illustrates a typical internal combustion engine with fuel injection, of a type with which the methods described herein may be used. In the example of FIG. 1, engine 100 is a gasoline engine. A stratified charge engine is one example of a gasoline engine that has lean and rich modes and that uses fuel injection. As indicated above, diesel engines also meet these criteria.

Various elements of engine 100 are known. Engine 100 is assumed to have an EGR (exhaust gas recirculation) loop, as well as various air handling devices. Air-handling actuators include valve(s) for EGR, SCV (swirl control valve), and VNT (variable nozzle turbo) actuators, and the like.

Engine 100 has a fuel injector and other fueling actuators. It further has appropriate sensors for acquiring various input values relevant to the methods described herein, such as those described below in connections with FIGS. 14, 27, 28, and 29. These sensors include sensors for measuring intake air temperature, pedal position, coolant temperature, engine speed, exhaust gas oxygen, intake air flow, exhaust air flow, etc.

Of particular relevance to the present invention is a combustion control unit 10, programmed to control various combustion control parameters in accordance with the methods described herein. Control unit 10 may be a processor-based unit having appropriate processing and memory devices. The memory of control unit 10 also stores various tables, which store maps of known values to variables. Values for these tables are acquired as described below, and then stored in control unit 10 for access during engine operation. Control unit 10 may be integrated with or part of a comprehensive engine control unit.

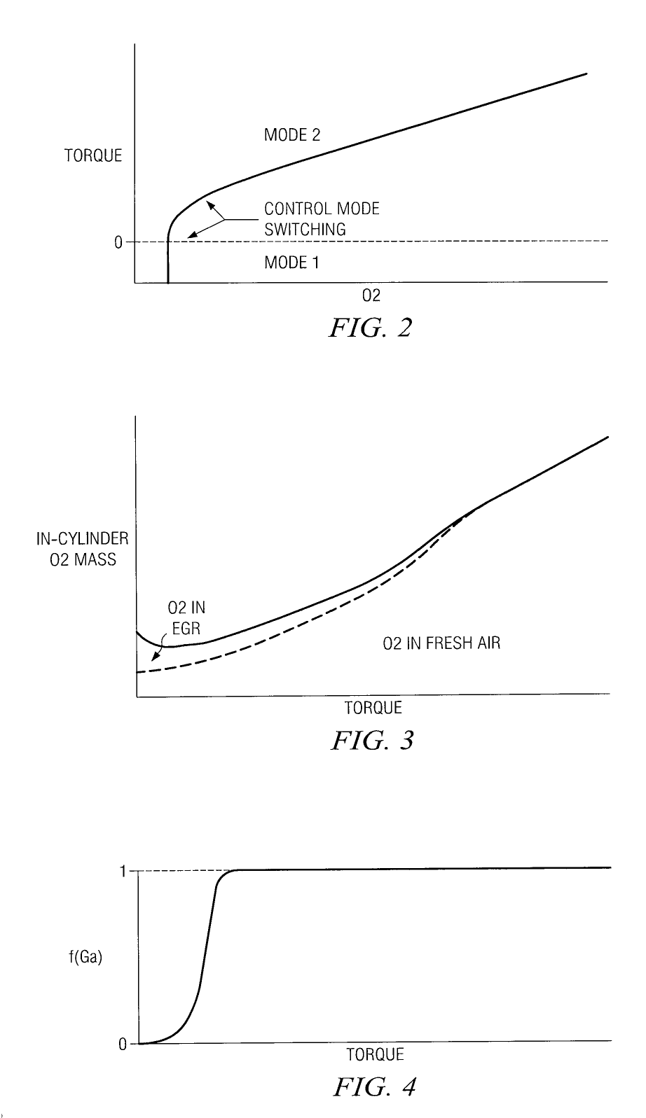

FIG. 2 illustrates the relationship between torque and total in-cylinder oxygen (O2) mass for optimal combustion in Modes 1 and 2. Engine torque increases with increasing O2 for most of the engine operating region. However, in Mode 1, O2 must increase while the engine torque decreases. This is necessary to maintain combustion stability. As a result, there can be two suitable torque points for a given O2 content. To avoid this situation, mode switching control methods have been developed that use only monotonic sections of the O2-torque relation.

More specifically, in Mode 0 the pedal position is 0 and torque is controlled by engine speed. As explained below, Mode 1 can be controlled using the same control method as Mode 2. Mode 0 and Mode 2 are connected directly. Torque passes smoothly between these two modes depending on smooth sweeping of a representative O2 value, referred to herein as O2ₐ*.

In Modes 2 and 3, combustion control methods are airflow-based. Airflow mass predicts torque (a representative value). More specifically, a torque representative factor, k, is selected based on predicted in-cylinder conditions (a temperature representative value and an O2 representative value) and engine speed (rpm).

Then, for Modes 2 and 3, the values of k and rpm determine the combustion control parameters. Fuel injection quantity and rail pressure are directly controlled by k and engine speed. Fuel injection timing (and ignition timing, in the case of a gasoline engine) are also decided by k and engine speed, but corrected by O2 concentration. Air-handling actuators are controlled by desired torque.

Mode 3, such as for LNT regeneration, starts at a point when O2 mass arrives at the desired O2 mass for rich combustion at the desired torque. To keep suitable rich operation, air handling actuator positions are decided from current actuator positions and a differential of pedal position. In Mode 3, the fuel injection quantity is corrected, using exhaust sensor feedback, to obtain a desired air fuel ratio.

During Modes 23 and 32, combustion control parameters are based on desired torque and in-cylinder conditions. Desired torque (representative) is defined from previous torque, the differential of pedal position, and engine speed. Fuel injection is controlled to adjust to torque under the in-cylinder condition. Empirical functions are used to define fuel injection quantity to keep the same torque under varying O2 mass from rich to lean condition. In the empirical functions, fuel injection mass is calculated from rich and lean fuel mass, which are defined from torque representative, ambient temperature and engine speed, and current O2 mass. Empirical functions are also used to define fuel injection timing at steady state condition to keep optimal combustion under varying O2 mass from rich to lean condition. To compensate the bias of O2 concentration at transient, an empirical function to correct injection timing is used.

### 2. Airflow-Based Control System for Mode 2

At a steady state engine operating condition, the torque representative, k, is decided by the following factors: representative O2 mass in fresh air, an in-cylinder temperature representative, and engine speed.

The in-cylinder O2 mass is the sum of the O2 mass in fresh air and O2 mass in EGR gas. However, in steady state conditions, the ratio of O2 in fresh air and EGR gas is constant at each operation point. Therefore, in steady state, O2 in fresh air, which increases monotonically with increasing torque, can be used to determine the value of the torque representative, k.

In transient conditions, the O2 mass in EGR deviates from that of steady state condition. To compensate for this effect, a “fake” (also referred to herein as a “representative”) value for O2 mass in fresh air, O2a*, is introduced. The ratio between fake and real O2 mass in fresh air is proportional to the transient and steady state in-cylinder O2 mass ratio. The value of the fake O2 mass increases monotonically with increasing pedal position.

In addition, a weighting factor, determined as a function of air flow mass, f(Ga), is introduced and multiplied to the deviated O2 mass in EGR from steady state. In most operating conditions, f(Ga)=1, which does not affect the value of (O2a*). However, at very light load, f(Ga)<1. Using this weighting factor, in-cylinder O2 mass is calculated and fake O2 in fresh air, O2a*, is recalculated. As a result, the torque representative, k, is reduced monotonically with decreasing O2a* including during special operations such as after a fuel cut. Fuel injection mass is decided by the torque representative value, k, and engine speed. Combustion timing (fuel injection or ignition) is decided by the torque representative, engine speed, and in-cylinder O2 concentration.

2.1 Representative in-Cylinder O2 Mass, O2a*

FIG. 3 illustrates the relationship between torque and in-cylinder O2 mass from both fresh air intake and EGR gas. To optimize combustion, the torque representative, k, should be related to the in-cylinder O2 mass. However, as illustrated, the total in-cylinder O2 mass does not change monotonically with torque. However, O2 in fresh air does change monotonically with torque. If fresh air O2 can be used to determine k, Mode 1 can be removed, making the control algorithm much simpler.

More specifically, at steady state, in-cylinder O2 mass (O2ₜₒₜₐₗ₋ₛₛ) is the total of O2 in fresh air (O2ₐ₋ₛₛ) and O2 in EGR (O2_{E-ss}). Expressed mathematically:

$$\begin{matrix}O {2}_{total - ss} = ( O {2}_{a - ss} ) + ( O {2}_{E - ss} ) \\ = O {2}_{a - ss} \{ ( O {2}_{a - ss} + O {2}_{E - ss} ) / O {2}_{a - ss} \} \\ = O {2}_{a - ss} / {C}_{0} ,\end{matrix}$$

where C_{O} is a “fresh O2 ratio” and C₀=O2ₐ₋ₛₛ/(O2ₐ₋ₛₛ+O2_{E-ss}).

In other words, O2ₜₒₜₐₗ₋ₛₛ is determined from O2ₐ₋ₛₛ and C₀. The value of C_{O} is determined by fresh airflow mass (Ga), temperature (T*), and engine speed (rpm) at steady state, and is less than 1. That is, C₀(Ga, T*, rpm)≦1.

At transient, in-cylinder O2 mass is,

$$\begin{matrix}O {2}_{total} = ( O {2}_{a} ) + ( O {2}_{E} ) \\ = O {2}_{a} / {C}_{0} + Δ O {2}_{E} ,\end{matrix}$$

where ΔO2_{E} is the deviation of O2 mass in EGR gas from steady state,

$$= O {2}_{a} ( 1 / {C}_{0} + {ΔO2}_{E} / O {2}_{a} )$$

When fake O2 mass in fresh air (O2ₐ*)is assumed,

O2ₜₒₜₐₗ=O2ₐ(1/C₀+ΔO2_{E}/O 2ₐ)=O2ₐ*/C₀ O2ₐ*=O2ₐ+C₀ΔO2_{E}

Thus, in the above-described manner, O2a* is calculated from the in-cylinder fresh air mass (O2a), the fresh O2 ratio (C₀=(O2 in fresh air)/(in-cylinder O2)) at steady state condition, and the deviation of O2 mass in EGR at transient from steady state (ΔO2_{E}). Various estimation methods can be used to estimate O2ₐ, such as the method based on air flow referenced in the Background.

Generally, the relation between O2a* and the accelerator pedal position is monotonical. However, in a special case, such as after a fuel cut, Δ)2_{E} becomes very big and O2a* becomes higher at lower pedal position. To avoid this problem, a fresh air flow weighting function, f(Ga), is introduced. This function is used to scale the value of ΔO2_{E}. The value of O2a*is manipulated with f(Ga) as follows:

O2ₐ*=O2ₐ+f(Ga)·C₀ΔO2_{E}

FIG. 4 illustrates f(Ga) as a function of torque. The value of f(Ga) changes from 0 to 1, and for most of engine operation, f(Ga)=1. However, at light load, where air fuel ratio is high enough and combustion is robust and not affected so much by in-cylinder condition, f(Ga) changes from 1 to 0. The manipulation of O2a*by f(Ga) at light load realizes the desired monotonic relation between O2a* and pedal position.

### 2.2 Temperature Representative Factor, T*

Temperature, T*, is a second important factor of the in-cylinder condition. The value T* includes the effect of coolant temperature(T_{cool})and intake temperature(Tᵢₙ).

T*=T_{cool}+f_{T}(Tᵢₙ−Tᵢₙ₋ₛₛ)

### 2.3 Calculation of O2a*

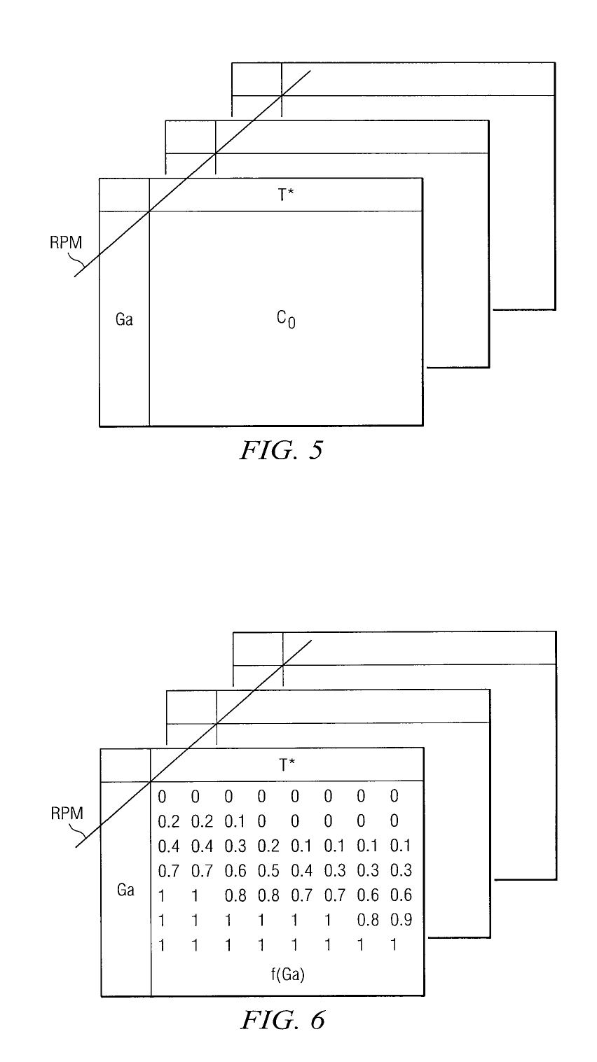

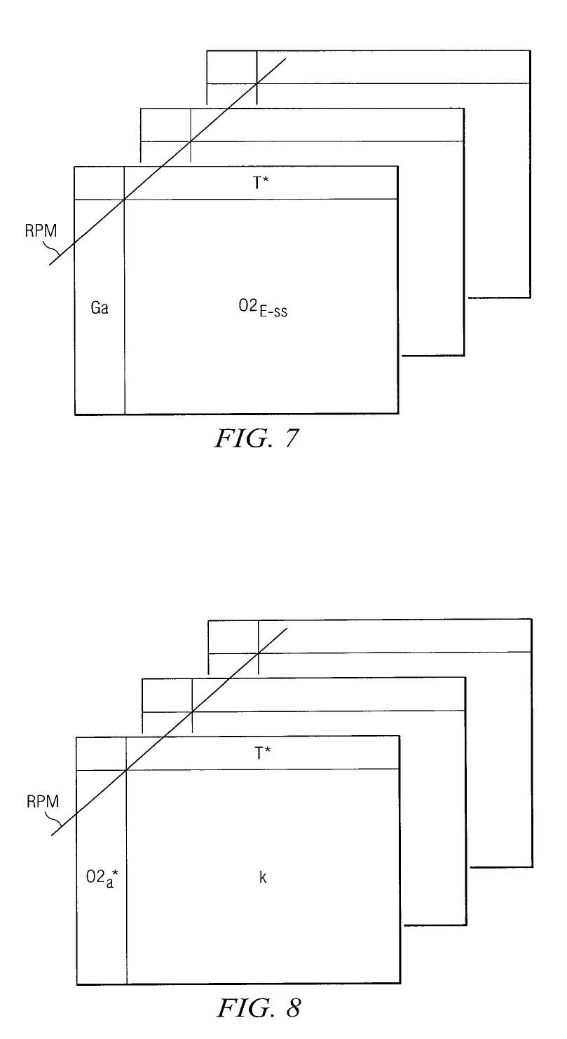

FIGS. 5, 6 and 7 illustrate how C₀, f(Ga) and O2_{E-ss} are mapped to T* and Ga. Different calculations are made for different engine speeds (rpm). From these maps, values of O2a* can be calculated, using the above-described mathematical calculations.

### 2.4 Torque Representative Factor, k

FIG. 8 illustrates how the torque representative factor, k, is determined from O2a*, T*and engine speed. The value of k increases with increasing O2a* monotonically.

As stated above, each value of k determines associated fueling parameters. These fueling parameters include:

Qf injection quantity (main, pilot, etc.)

θ injection timing (main, pilot, etc.)

Pᵣₐᵢₗ rail pressure

Fueling parameters are decided in steady state testing. Once k is determined, tables are created to map k and T* to fueling parameters for varying rpm.

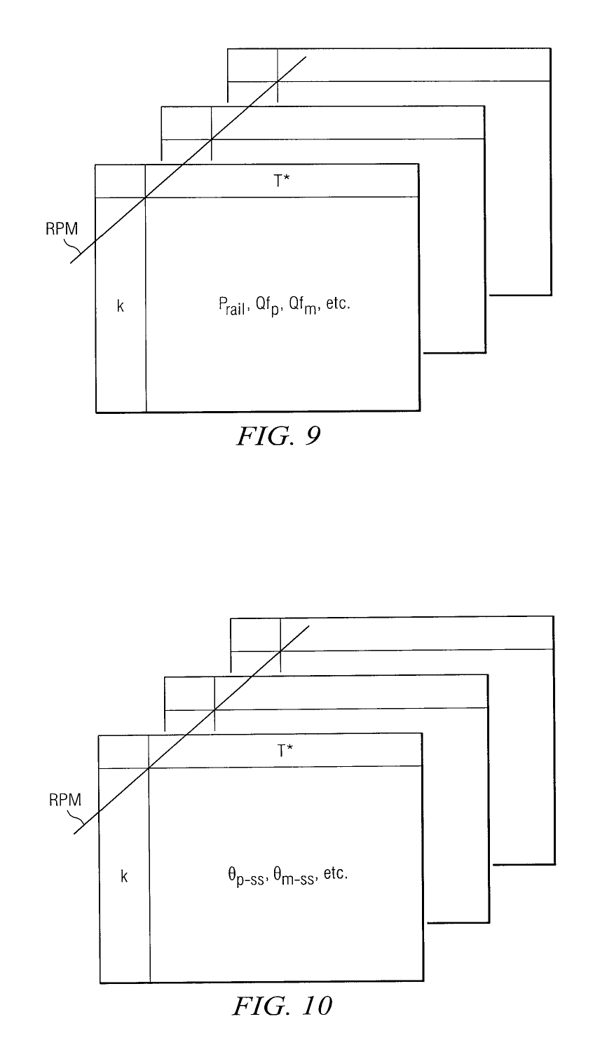

FIG. 9 illustrates how tables may be used to store values of fuel injection quantity and rail pressure, as mapped from (decided from) k, T*, and rpm. Fueling parameters for main versus pilot injection are distinguished by subscripts, m, p, etc. Thus, these parameters are determined directly from steady state maps.

FIG. 10 illustrates a table of fuel injection timing, also mapped from k, T*, and rpm. Steady state conditions are indicated by the additional subscript, -ss. As explain below, the injection timing parameter is corrected by O2 concentration.

### 2.5 Fuel Injection Timing Correction by O2 Concentration

Combustion characteristics, such as fuel consumption, combustion noise, stability, smoke, and engine out NOx, are significantly affected by both injection timing and the air-fuel ratio (namely EGR rate or O2 concentration at the same injection quantity).

The O2 concentration at steady state is denoted by O₂_{c-ss}. When this value is lower at the same k and rpm, injection timing should be advanced. This injection timing advancement is denoted by Δθ (main or pilot), where:

Δθ_{p, m, etc.}=θ_{p, m, etc.}−θ_{p-ss, m-ss, etc.-ss}

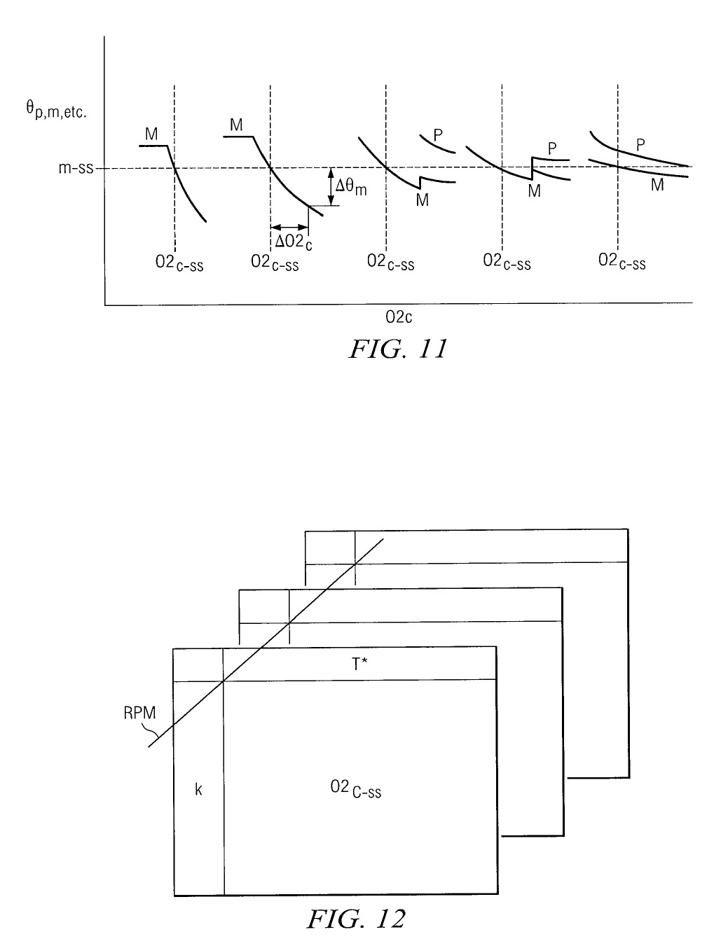

FIG. 11 illustrates the optimal relation between O2_{c-ss} and injection timing. When the O2 concentration at steady state is lower (except at very low load where f(Ga)<1), the injection timing advancement should be bigger for the same ΔO2_{c} (the bias of O2 concentration at transient from steady state).

FIG. 12 illustrates maps of O2_{c-ss} from k, T*, and rpm at from steady state. From an in-cylinder O2 estimation model or intake O2 sensor, the bias of O2 concentration at transient from steady state is calculated as:

ΔO2_{c}=O2_{c-current}−O2_{c-ss}

Referring again to FIG. 10, an “uncorrected” injection timing parameter may be mapped to k, T*, and rpm. From O2_{c-ss} and ΔO2_{c} at each engine speed, an injection timing correction factor, Δθ_{p, m, etc.}, is determined by the following empirical function:

Δθ_{p, m, etc.}=a(ΔO2_{c})^{b}

, with the qualification that if θ_{p, m, etc.}>critical (such as may be limited by combustion chamber or nozzle geometry), θ=θ(max).

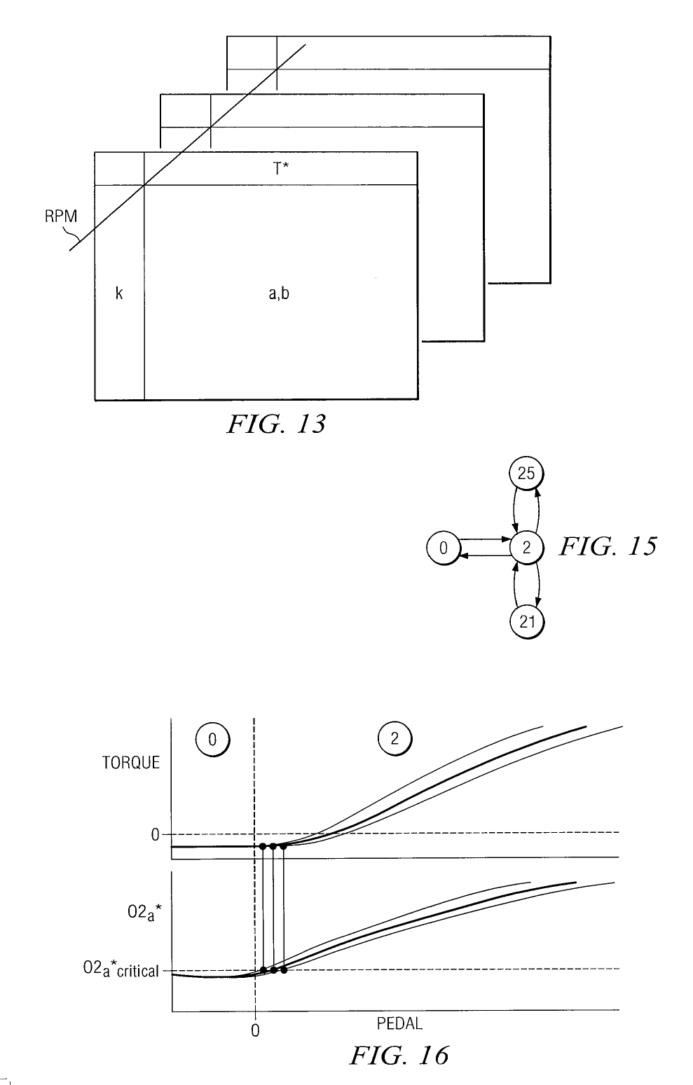

FIG. 13 illustrates how values for a and b are decided from k, T*, and rpm.

Using these maps and functions, a corrected injection timing value, θ_{p, m, etc.}, is calculated as the sum of the “uncorrected” timing value and the correction factor.

θ_{p, m, etc.}=θ_{p-ss, m-ss, etc.-ss}+Δθ_{p, m, etc.}

### 2.6 Combustion Control for Mode 2

FIG. 14 illustrates how the above-described tables and calculations are used to determine fueling control parameters.

In Step 141a, various input values are acquired by measurement or otherwise. These values include engine speed (rpm) and pedal position. Referring again to FIG. 1, the engine may include various sensors for obtaining these measurements, as well as other measured values discussed herein.

In Step 141b, values are determined for various air handling actuator positions. Air handling actuators include EGR, SCV, and VNT, and the like. In the example of FIG. 14, a first map is used to obtain an air handling representative value, i, from factors such as rpm and pedal position. Then a second map is used to obtain air handling position values from i and rpm.

In Step 141c, values are determined for airflow mass (Ga), exhaust oxygen concentration (λ), intake pressure, intake air temperature (Tᵢₙ), and engine coolant temperature (T_{cool}).

In Step 142, as described above in Part 2.2, a temperature representative value, T*, is calculated from the coolant temperature and intake temperature.

In Step 143, as described above in Part 2.1, an in-cylinder estimation model is used to determine values of O2ₐ, O2ₑ and O2_{c}. More specifically, the total in-cylinder gas flow (per cycle) is the total of the fresh air flow (Ga) and the EGR flow (Ge), which each have an O2 component, O2ₐ and O2ₑ, respectively. The total in-cylinder oxygen, O2_{c}, is the total of O2ₐ and O2ₑ. Various “in-cylinder O2 estimation” methods can be used to estimate O2_{c}, such as the methods described in U.S. Pat. No. 7,163,007, incorporated by reference herein.

In Step 144, as described above in connection with FIGS. 5-7, values of Ga, T*, and rpm are used to determine values of the deviation of O2 mass in EGR from steady state (ΔO2_{E-ss}), the fresh air O2 ratio (C_{O}) and the air flow mass function (f(Ga)).

In Step 145, as described above, the values determined in Step 144 are used to determine a value for a “fake” or “representative” O2 mass in fresh air, O2ₐ*.

In Step 146, as described above in connection with FIG. 8, a torque representative value, k, is determined from O2ₐ*, T*, and rpm.

In Step 147, as described above in connection with FIG. 9, values for fuel injection quantity and pressure can be obtained from tables of k, T*, and rpm.

In Step 148, as described above in connection with FIGS. 10, 12, and 13, values for “base” fuel injection (or ignition) timing, oxygen concentration at steady state, and a and b values are obtained from tables.

In Step 149, the O2_{c} value determined in Step 143 and the O2_{c-ss} value from the table of FIG. 12 are used to calculate a value for an oxygen concentration bias, ΔO2_{c}.

In Step 150, a timing correction factor, Δθ, is calculated from the ΔO2_{c} value determined in Step 149 and from the a and b values obtained in Step 148.

In Step 151, a “corrected” timing parameter is determined from the correction factor and the “base” timing parameter determined in Step 150 and from the table of FIG. 10.

### 2.7 Mode 0 to Mode 2 Switching

As illustrated in FIG. 15 and referring again to FIGS. 2 and 3, using the control process of FIG. 14, Mode 1 is removed. Mode 0 and Mode 2 are connected directly.

The lean combustion control process may include normal operation mode (Mode 2), idle mode (Mode 0 with torque is controlled by engine speed), high acceleration mode (Mode 25 with bootstrapping), and high deceleration mode (Mode 21 with quick O2 reduction to avoid over run).

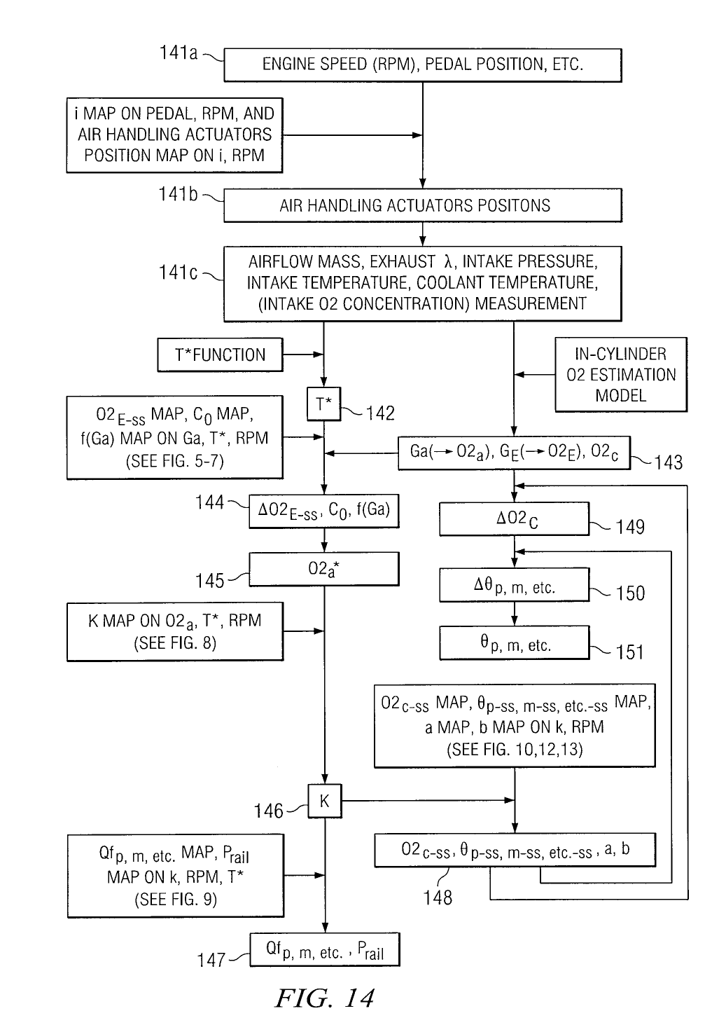

FIG. 16 illustrates how O2a* is gradually reduced with reducing pedal position when switching from Mode 2 to Mode 0. In this case, the critical (fake) O2 mass of fresh air (O2ₐ*_{critical}) is a little higher than the O2 of fresh air at steady state idling (pedal=0) condition. When the engine speed is high and its fuel is cut, fuel injection starts at O2ₐ*=O₂ₐ*_{critical}, not at pedal on point. If O2ₐ*<O2ₐ*_{critical} with pedal on, fuel is injected. The relation between pedal position and O2ₐ* can change, but permits the driver to operate the vehicle without the torque shock caused by control mode switching at pedal 0 areas.

### 3. Airflow-Based Control for Modes 3, 23, and 32

Mode 3 is rich operation. Modes 23 and 32 are switching operations from lean-to-rich and rich-to-lean, respectively.

Several basic control factors for these modes are k (the torque representative value), O2 (the in-cylinder O2 mass in lean operation), and i (a representative value of air-handling actuator positions). However, for Modes 3, 23, and 32, these basic control factors are qualified from those of Mode 2, as explained below.

In Mode 3, as in Mode 2, combustion control is airflow-based. The torque representative value is referred to as k_{R}, and is based on predicted in-cylinder conditions and engine speed. Then the values of k_{R} and engine speed determine the combustion control parameters. Air-handling actuators are controlled by desired torque.

During Modes 23 and 32, combustion control is based on airflow and desired torque representative k (as affected by pedal position). The torque representative value is referred to as k_{LR} or k_{RL} (and collectively as kₜ). Combustion control parameters are determined by kₜ and in-cylinder conditions, but k is allowed to change with changing desired torque. Air-handling actuators are controlled to achieve desired in-cylinder conditions such as desired in-cylinder O2 mass.

### 3.1 Key Factors (k, O2, and i) for Modes 3, 23, and 32

Control of fueling parameters during the transient periods (lean to rich or rich to lean) is explained using subscripts LR, RL, and t. The subscript “t” refers to both Modes 23 and 32.

### Torque Representative

For Mode 23, the torque representative, k_{LR}, is decided from the previous torque representative value, differential of pedal position, and current engine speed. In Mode 3, k_{R} is decided from in-cylinder conditions. In Mode 32, the torque representative, k_{RL}, is determined from the previous torque representative, differential of pedal position, and current engine speed.

### O2 Mass

O2_{R} is the total in-cylinder O2 mass for rich operation in Modes 23, 3, and 32. The physical definition is the same as for O2ₜₒₜₐₗ=O2ₐ*/C₀ in Mode 2.

### Air Handling Representative

For Modes 3, 23, 32, an air handling representative value, i_{R}, is introduced. The value of i_{R} is decided by engine speed and pedal position, and decides each air handling actuator's position.

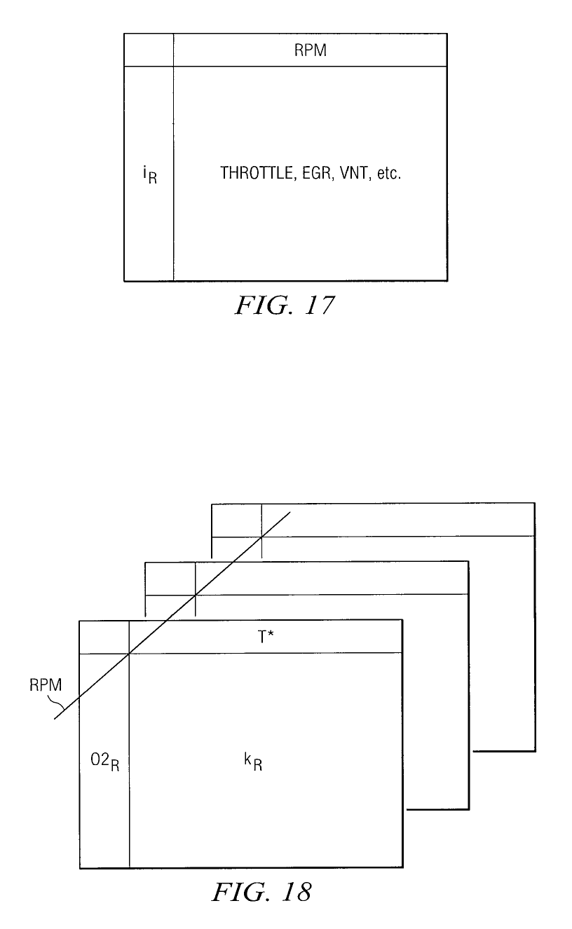

FIG. 17 illustrates how i_{R} and rpm are mapped to positions of various air-handling actuators. At steady state condition, O2_{R} increases with increasing i_{R}. For overshooting in Mode 23, i_{R} is reduced. It is increased in Mode 32.

### 3.2 Mode 3 Control Factors

FIG. 18 illustrates steady state tables that map current engine speed, T* and O2_{R} to values of k_{R}. The temperature representative T* is calculated in the same manner as described above for Mode 2. (T*=T_{cool}+f_{T}(Tᵢₙ−Tᵢₙ₋ₛₛ).

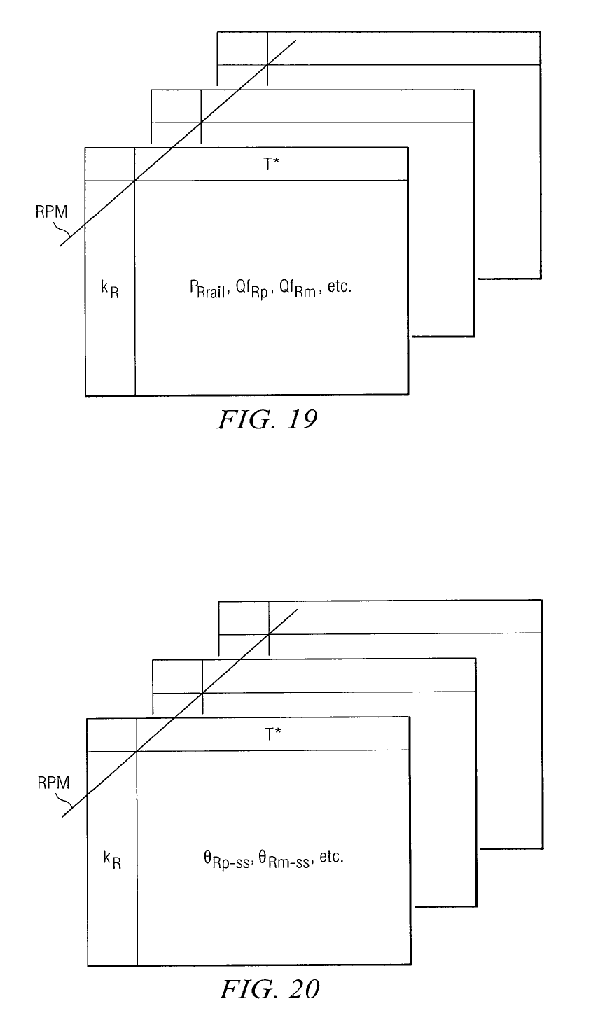

FIG. 19 illustrates how various fueling parameters are determined from k_{R},T*,and rpm.

FIG. 20 illustrates how injection timing before correction (θ_{R-ss}) is also decided from rpm, T*, and k_{R}, using steady state mapping.

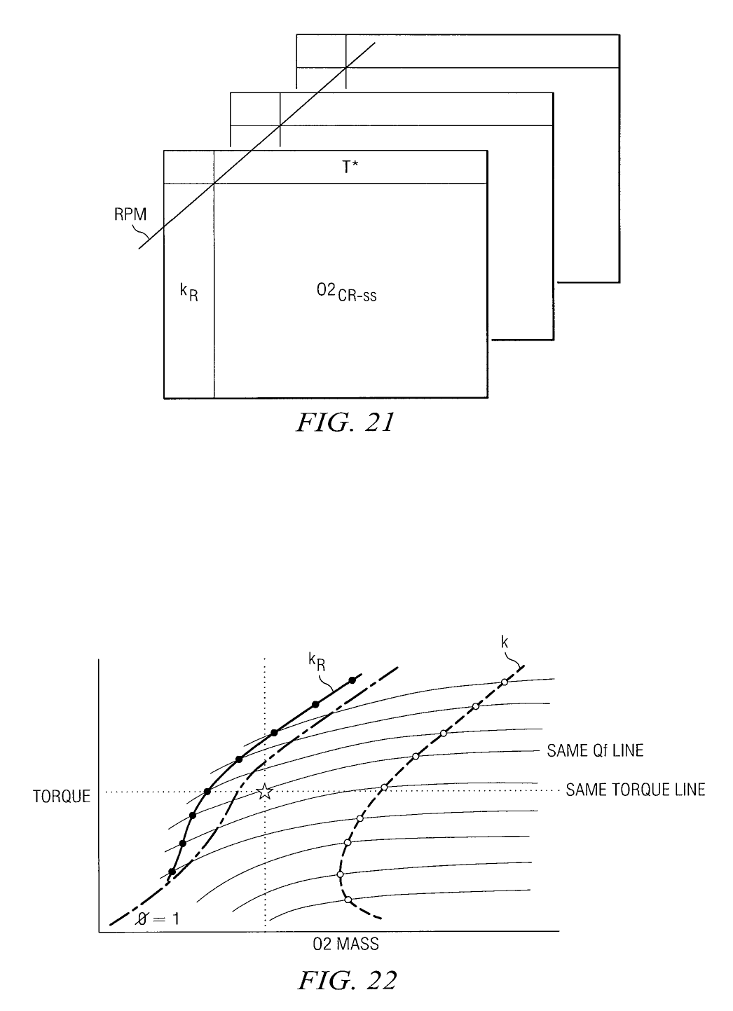

FIG. 21 illustrates mapping of rpm and k_{R} to O2 concentration at steady state test (O2_{CR-ss}) for the use in correction of injection timing.

As in Mode 2, Mode 3 injection timing is corrected by O2 concentration (O2_{CR}). The relation between O2_{CR} and optimal injection timing is similar to that of FIG. 11, with the substitution of O2_{CR} for O2_{C}. An injection timing correction factor for Mode 3 (Δθ_{RP, Rm, etc.}) is decided with an empirical function:

Δθ_{Rp, Rm, etc.}=a_{R}·(ΔO2_{CR})^{b}^{_{R}}

In a manner similar to FIG. 13, parameters a_{R} and b_{R} are decided from k_{R}, T* and rpm for each injection (pilot, main, etc.). If θ_{Rp}, Rm, etc. >critical as limited by constraints such as the combustion chamber or nozzle geometry), θR=θR(Max). Using these maps and functions, injection timing (θ_{p, m, etc.}) is corrected to compensate for the bias of O2 concentration at each k_{R}, T* and rpm.

3.3 Modes 23 and 32; Relation Between kₜ, O2_{R} and T*

FIG. 22 illustrates the relationship between O2 mass, k (torque representative), and fuel injection mass. The solid curve is the relation between current O2 mass and the torque representative k_{R} of rich operation at current T*. The dashed curve is the relation between current O2 mass and torque representative k of lean operation at current T*. These two curves can be plotted from the tables described above, from current temperature representative T*, and from engine speed.

Before fuel injection, a desired k is predicted from the previous k value, pedal differential, and engine speed, desired “k” is predicted (dotted horizontal line). From current O2 mass and T*, a desired point (star point) can be defined. The near-horizontal curves indicate the same fuel injection mass.

To determine fuel injection mass (Qfₚ, Qfₘ, etc.), an empirical function is introduced with or without a mid O2 concentration map. The following functions can be applied to both Mode 23 and Mode 32, as indicated by the subscript “t”.

Qfₚₜ=Qfₚₜ(Qfₚ, Qf_{Rp}, O2)

Qfₘₜ=Qfₘₜ(Qfₘ, Qf_{Rm}, O2)

Pᵣₐᵢₗₜ=Pᵣₐᵢₗₜ(Pᵣₐᵢₗ, P_{Rrail}, O2)

Injection timing before correction is also defined by empirical functions.

θₚ₋ₛₛₜ=θₚ₋ₛₛₜ(θₚ₋ₛₛ, θ_{Rp-ss}, O2_{C})

θₘ₋ₛₛₜ=θₘ₋ₛₛₜ(θₘ₋ₛₛ, θ_{Rm-ss}, O2_{C})

The correcting factor, Δθ, is decided from empirical functions of aₜ and bₜ. Values of aₜ and bₜ can be interpolated from a, b and a_{R}, b_{R} proportionally.

aₚₜ=aₚₜ(aₚ, a_{pR}, O2_{C})

aₘₜ=aₘₜ(aₘ, a_{mR}, O2_{C})

bₚₜ=bₚₜ(bₚ, b_{pR}, OC)

bₘₜ=bₘₜ(bₘ, b_{mR}, O2_{C})

Fuel injection timing is decided as:

θₚₜ=θₚ₋ₛₛₜ+θₚ₋ₛₛₜ, =θₚ₋ₛₛₜ, +aₚₜ·(ΔO2_{C})^{b}^{ₚₜ}

θₘₜ=θₘ₋ₛₛₜ+Δθₘ₋ₛₛₜ, =θₘ₋ₛₛₜ, +aₘₜ·(ΔO2_{C})^{b}^{ₘₜ}

### 3.4 Switching Control for Modes 3, 23, and 32

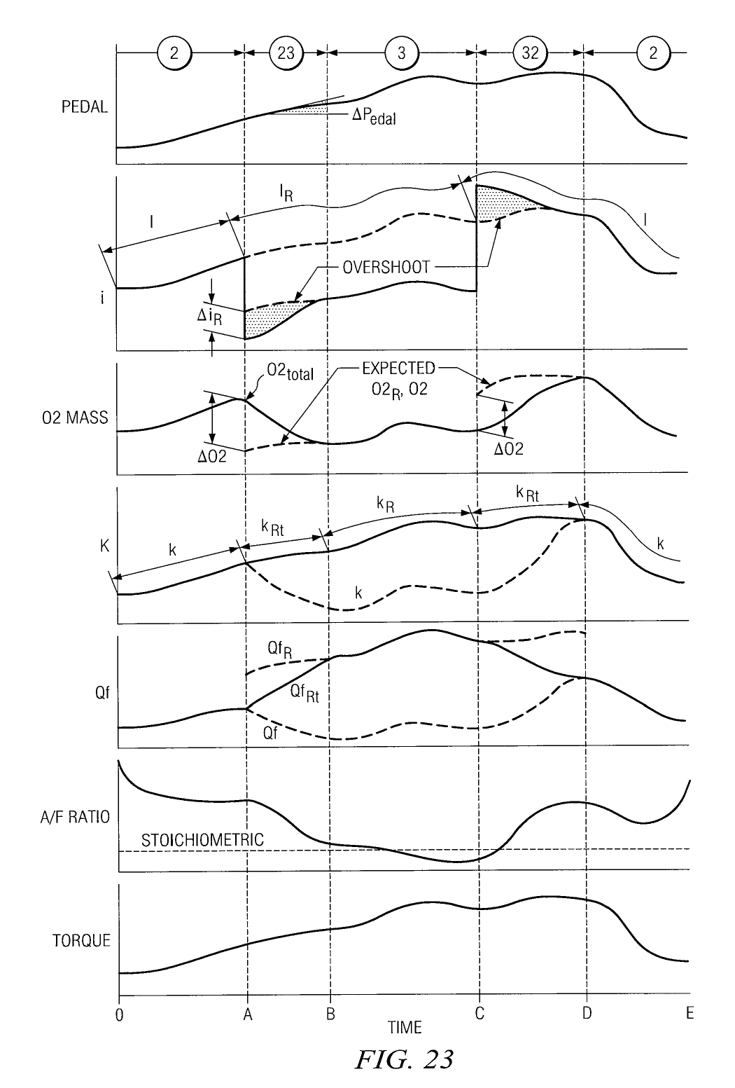

FIG. 23 illustrates mode timing. From the start (time=0) to point A, the engine is operated in Mode 2 (normal lean operation). Mode 23 (lean to rich transient) is from point A to point B. Mode 3 (rich operation) is from point B to point C. Mode 32 (rich to lean transient) is from point C to point D. Mode 2 is from point D to end.

At point A (at the end of Mode 2), the O2 mass in cylinder (O2ₜₒₜₐₗ) was calculated from Mode 2 logic (O2ₐ*→O2ₜₒₜₐₗ). The torque representative, k, is decided from O2ₐ*in Mode 2.

In Mode 23 (lean to rich transient), the desired torque representative is decided from the previous value, engine speed, and differential of pedal position (ΔP_{edal}). In other words,

k_{LR}=k_{LR}+Δk_{LR}(ΔP_{edal})

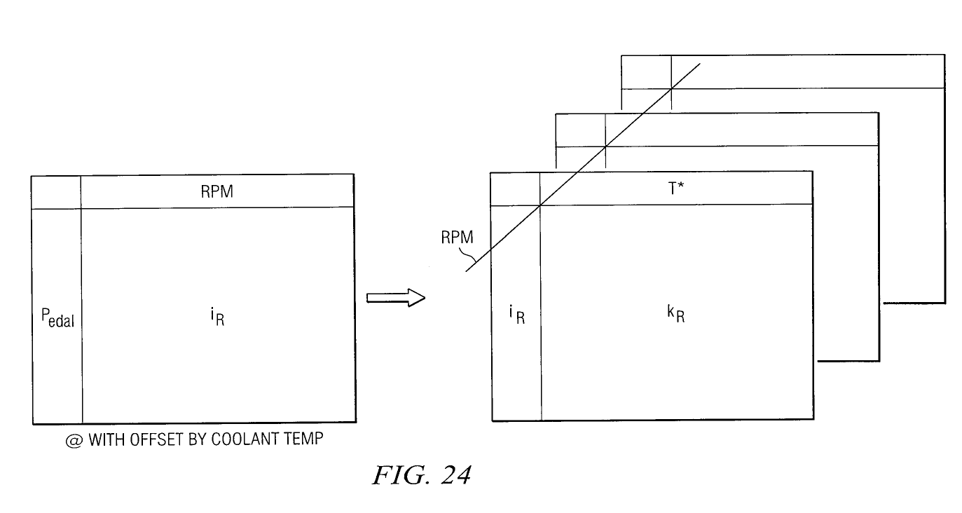

FIG. 24 is a steady state rich map of the relation between ΔP_{edal} and Δk_{LR}. Referring again to FIG. 23, in Modes 23, 3, and 32, the desired torque representative value is bigger than the k calculated from Mode 2 logic (dotted line).

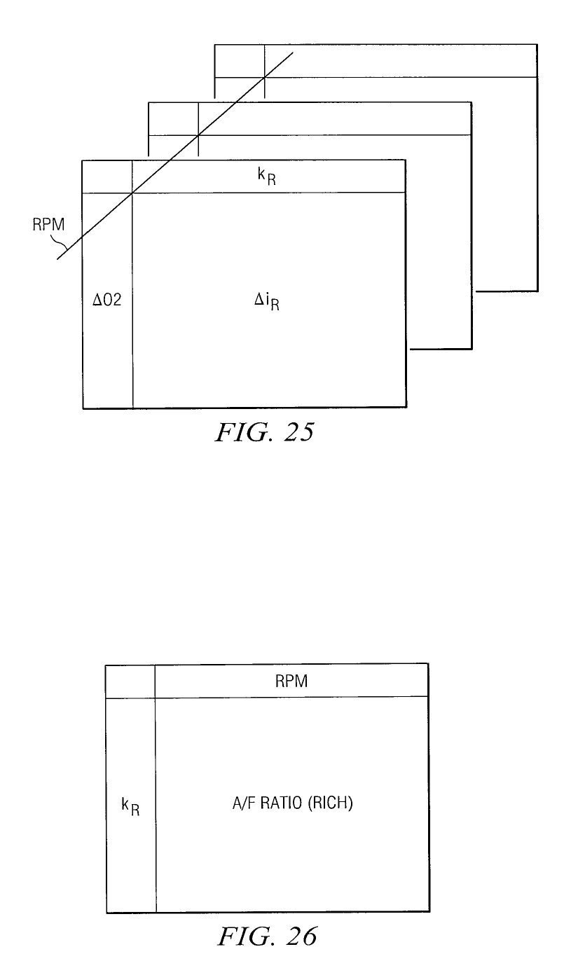

The value of i_{LR} is decided from current pedal position and engine speed plus an overshooting value Δi_{R}(→i_{LR}=i_{LR}+Δi_{R}). As illustrated in FIG. 25, the overshooting value for Δi_{R} is decided from k (k_{R}), ΔO2(current O2−expected O2_{R}), and engine speed.

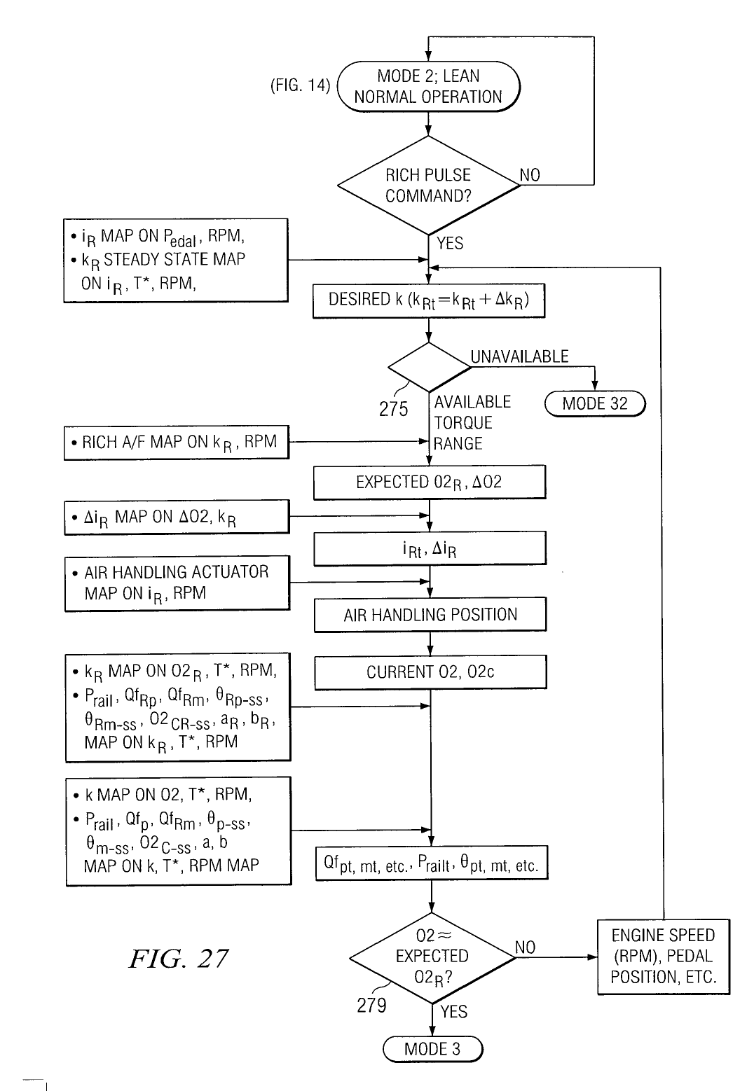

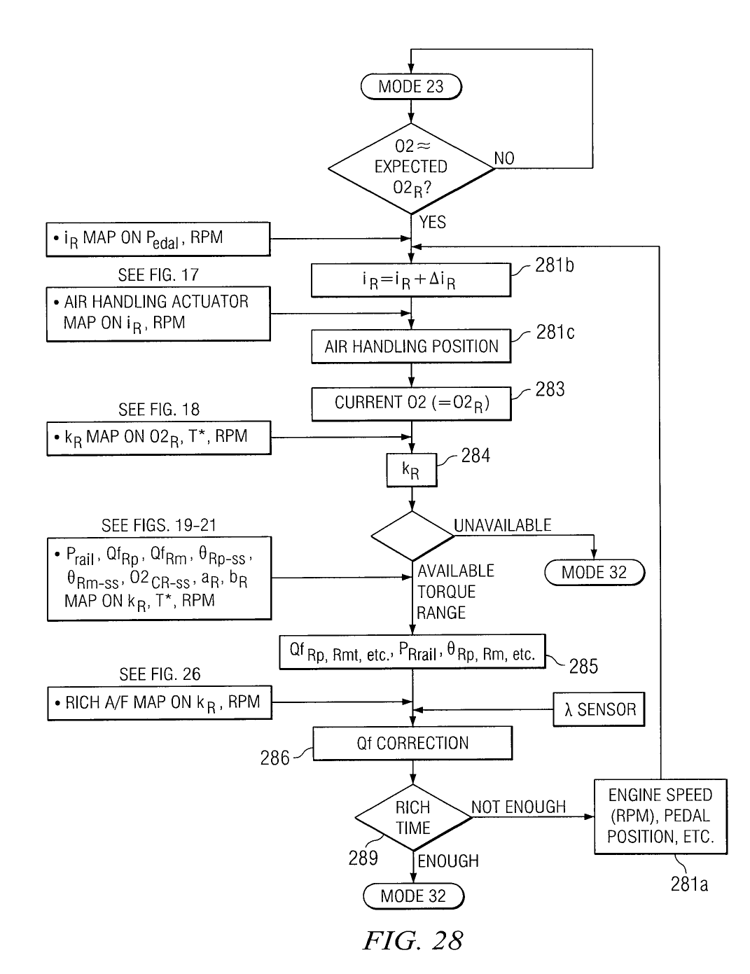

As illustrated in FIG. 26, the expected O2_{R} is calculated from a desired A/F ratio map (rich) on k_{R} and rpm.

From measured current O2 mass and T*, fuel quantity is calculated from empirical functions described above in Part 3.3. From O2 concentration, injection timing is corrected with empirical functions as described above.

FIGS. 27, 28, and 29 are flowcharts for Modes 23, Mode 3, and Mode 32, respectively. Many of the steps are analogous to those of Mode 2 discussed above in connection with FIG. 14.

As illustrated in FIG. 27, Mode 23 starts in response to a rich pulse command. When the control mode is switched from lean to rich (Mode 23), the torque representative (representative of desired torque) and the desired in-cylinder O2 mass for rich combustion (O2_{R}) are decided from the previous (one cycle before) torque representative, the differential of pedal position (Δpedal), and current engine speed. Air handling actuators are controlled to reach the targeted in-cylinder O2 mass (O2_{R}) corresponding with the O2 mass of the targeted torque representative of Mode 3. When the difference between current and targeted O2 mass is big, air handling actuator positions are changed strongly with overshooting. When the difference becomes smaller, the change of air handling actuator positions becomes smaller. The torque representative is decided to adjust to the targeted torque at the current O2 mass. Fueling parameters and ignition timing are optimized to adjust to the in-cylinder condition (O2 mass, O2 concentration, and temperature representative).

The steps of FIG. 27 are referenced to the maps and steps described above in connection with FIGS. 24-26. In Step 275, if the desired torque in not available at rich combustion, the control mode is changed to Mode 32. In Step 279, if in-cylinder O2 becomes close to expected O2_{R} (rich air fuel ratio), control mode is changed to Mode 3.

Referring to both FIGS. 23 and 27, Mode 3 (rich operation) begins at Point B, as decided by O2 mass. In Step 279, it is determined whether the O2 mass has arrived at the expected O2_{R} for the desired torque. If so, Mode 3 begins.

FIG. 28 is a flowchart of Mode 3 control. In Step 281a, measurements for rpm and pedal position are obtained.

In Step 281b, the air handling representative value i_{R} is decided from previous i_{R} and the differential of pedal position. In other words, i_{R}=i_{R}+Δi_{R}(Δpedal₁). The value of Δi_{R} is decided from a map like that of FIG. 25.

In Step 281c, tables are used to obtain air handling position values from i_{R} and rpm.

As indicated by Steps 283 and 284, the torque representative value for Mode 3, k_{R}, is controlled by 02. The logic is the same as for Mode 2 but specified for rich operation. FIG. 18 and its accompanying description provides further detail.

In Step 285, fueling parameters are determined as described above. In Step 286, the fuel injection quantity is offset to obtain a desired air fuel ratio (using λ sensor feedback and a desired A/F ratio map such as that of FIG. 26). FIGS. 19-21 and their accompanying description provide further detail.

In Step 289, once the exhaust oxygen, λ, arrives at the target value, the control mode is changed to Mode 32. There may be some delay (from 0 to four seconds).

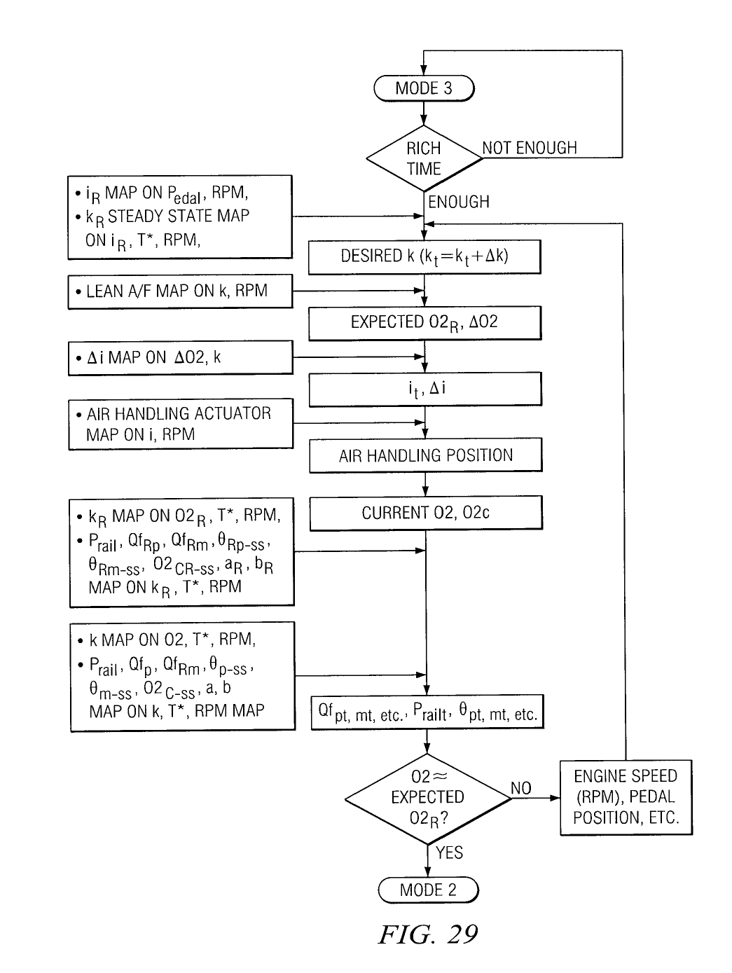

FIG. 29 is a flowchart of Mode 32 control. In Mode 32 (rich to lean transient), the desired torque representative is decided from the previous torque representative value, engine speed, and the differential of pedal position (ΔP_{edal}). In other words, k_{RL}=k_{RL}+Δk(ΔP_{edal}).

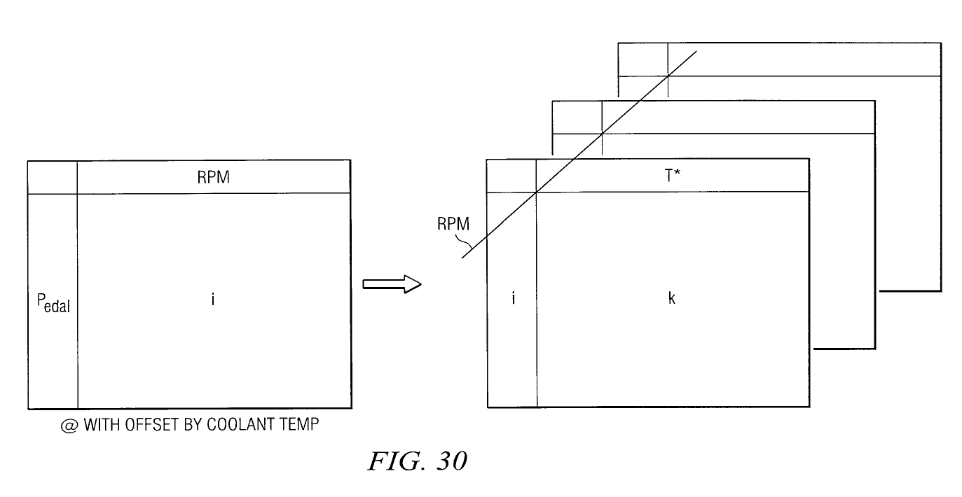

FIG. 30 is a steady state lean map, used to determine the relation between ΔPedal and Δk. Referring again to FIG. 23, k_{RL} is bigger than the k calculated at Mode 2 (dotted line).

The value of iₜ is decided from current pedal position and engine speed on the lean operation map plus an overshooting value Δi. In other words, iₜ=iₜ+Δi.

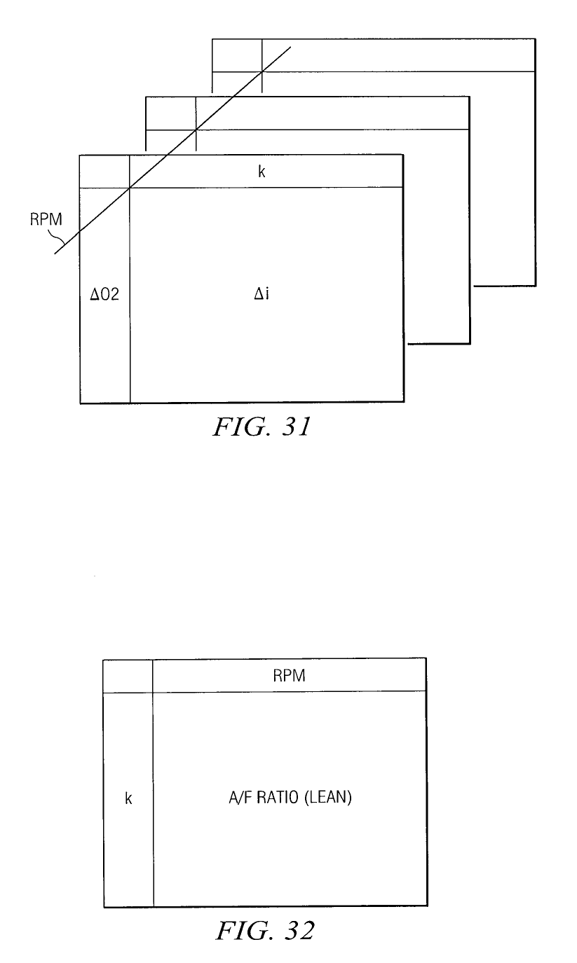

As illustrated in FIG. 31, the value of Δi is decided from k_{RL}, ΔO2 (current O2−expected O2) and engine speed. When the torque representative of Mode 32 is much bigger than that of Mode 2, overshooting of air handling actuators is used, and if the difference is small, overshooting is not used. The overshooting value is reduced to zero before the end of Mode 32.

As illustrated in FIG. 32, the expected O2 is calculated by mapping k and rpm to desired A/F ratio map (lean).

From measured current O2 mass and T*, fuel quantity is calculated from empirical functions. From O2 concentration, injection timing is corrected with empirical functions as explained above in Part 3.3.

When the current O2 mass arrives as expected at point D, the control mode is changed to Mode 2.

What is claimed is:

1. A method of controlling combustion of an internal combustion engine during a lean mode of the engine, comprising:
storing, in a control unit, at least one combustion control table that defines at least one combustion control value in terms of engine speed, a temperature representative value, and a torque representative value;
during operation of the engine, receiving values representing engine speed, temperature, and intake air flow;
in response to the preceding step, calculating the representative in-cylinder fresh air oxygen value and the representative temperature value;
wherein the representative in-cylinder fresh air oxygen value is calculated at least in part from measured intake air flow;
using the values calculated in the preceding step and the engine speed value to determine the representative torque value;
accessing the combustion control table, such that the representative torque value, the temperature value, and the engine speed value are used to determine at least one combustion control value; and
using the combustion control value from the previous step to control an associated combustion control mechanism.

2. The method of claim 1, further comprising the steps of determining at least one air handling representative value and of using the air handling representative value to determine at least one air handling actuator position value, prior to the step of calculating the representative in-cylinder fresh air oxygen value.

3. The method of claim 1, wherein the temperature representative value is calculated from intake temperature and coolant temperature.

4. The method of claim 1, wherein the in-cylinder fresh air oxygen representative value is calculated from an estimated value of in-cylinder oxygen from fresh air added to the product of a fresh air flow weighting function, the ratio of in-cylinder oxygen in fresh air to total in-cylinder oxygen, and the deviation of oxygen mass in recirculated exhaust gas from steady state.

5. The method of claim 4, wherein the weighting function varies from 0 to 1 and varies during light load conditions of the engine.

6. The method of claim 4, wherein the weighting function is determined by storing and accessing a table of air flow, temperature, and engine speed values mapped to weighting function values.

7. The method of claim 4, wherein the ratio of in-cylinder oxygen from fresh air to total in-cylinder oxygen is determined by storing and accessing a table of air flow, temperature, and engine speed values mapped to values of the ratio.

8. The method of claim 4, wherein the deviation of oxygen mass in recirculated exhaust gas from steady state is determined by storing and accessing a table of air flow, temperature, and engine speed values mapped to values of the deviation.

9. The method of claim 1, wherein the at least one fueling parameter is fuel injection quantity.

10. The method of claim 1, wherein the at least one fueling parameter is rail pressure.

11. The method of claim 1, wherein the at least one fueling parameter is injection or ignition timing, and further comprising the step of correcting a base timing parameter with an O2 concentration correction factor.

12. The method of claim 11, wherein the correction factor advances timing when oxygen concentration is lower than at steady state.

13. A method of controlling combustion of an internal combustion engine during a rich mode of the engine, comprising:
storing, in a fueling control unit, a fueling quantity control table that defines fueling quantity control values in terms of engine speed, a temperature representative value, and a torque representative value;
during operation of the engine, receiving values representing engine speed, temperature, and intake air flow;
in response to the preceding step, calculating the representative in-cylinder total oxygen value and the representative temperature value;
wherein the representative in-cylinder total oxygen value is calculated at least in part from measured intake air flow;
using the values calculated in the preceding step and the engine speed value to determine the representative torque value;
accessing the fueling quantity control table, such that the representative torque value, the temperature value, and the engine speed value are used to determine a fueling quantity control value;
correcting the fueling quantity control value based on a desired air-fuel ratio and feedback from an exhaust oxygen sensor; and
using the fueling quantity control value from the previous step to control fuel injection.

14. The method of claim 13, further comprising the steps of storing additional fueling parameter base maps for additional fueling parameters, and wherein accessing step is performed to obtain additional fueling control values.

15. The method of claim 13, further comprising the initial step of beginning the rich mode when the oxygen concentration reaches a rich mode oxygen concentration.

16. The method of claim 13, further comprising the steps of determining at least one air handling representative value and of using the air handling representative value to determine at least one air handling actuator position value, prior to the step of calculating the representative in-cylinder total oxygen value.

17. The method of claim 16, wherein the air handling representative value is determined from a current air handling representative value and a differential of pedal position.
